(19) United States
(12) Patent Application Publication
(10) Pub. No.: US 2012/0035813 A1
(43) Pub. Date: Feb. 9, 2012

(54) Wall Movement Synchronization Slide-Out Room System and Method

(76) Inventor: Craig J. Kreil, Mishawaka, IN (US)

(21) Appl. No.: 13/197,291

(22) Filed: Aug. 3, 2011

Related U.S. Application Data
(60) Provisional application No. 61/371,557, filed on Aug. 6, 2010.

(51) Int. Cl. B60P 3/34; G06F 17/00

(52) U.S. Cl. 701/49; 296/26.13

(57) ABSTRACT

A slide-out room system for a vehicle includes a slide-out room movably connected to the vehicle and at least four room slides supported by the vehicle and operable to move the slide-out room relative to the vehicle. A first of the four room slides is disposed in a first quadrant of the slide-out room, a second of the four room slides is disposed in a second quadrant of the slide-out room, a third of the four room slides is disposed in a third quadrant of the slide-out room, and a fourth of the four room slides is disposed in a fourth quadrant of the slide-out room. The system further includes a controller operatively connected to each of the four room slides for independently controlling the motion of the four room slides and synchronizing the motion of the four room slides to move the quadrants in concert with one another.

### CROSS-REFERENCE TO RELATED APPLICATIONS

This application claims the benefit of U.S. Provisional Patent Application No. 61/371,557 filed Aug. 6, 2010, the disclosure of which is hereby incorporated by reference in its entirety.

### STATEMENT REGARDING FEDERALLY SPONSORED RESEARCH OR DEVELOPMENT

Not applicable.

### FIELD OF THE INVENTION

This invention generally relates to slide-out rooms of recreational vehicles, and more particularly, slide-out rooms having multiple room slides.

### BACKGROUND OF THE INVENTION

Some recreational vehicles include a slide-out room to increase the size of the living quarters while also providing an appropriate size for highway travel. Some slide-out rooms extend from the side of a vehicle and are moved by one or more actuators, such as hydraulic cylinders, electric drive screws, or electric gear drives located on the vehicle. In the case of multiple actuators, a controller may be used to ensure synchronized movement of the actuators. Otherwise, the actuators may move at different rates and thereby extend the slide-out room to a skewed position relative to the vehicle. In such a skewed position the slide-out room may not properly engage seals at interfaces between the slide-out room and the rest of the vehicle, which may ultimately cause leaks or drafts between the slide-out room and the outside environment.

In some previous recreational vehicle designs having a slide-out room, actuators were only provided at a single side of the slide-out room (e.g., below the floor). Such systems were capable of ensuring synchronized movement along the single side of the room and sufficiently engaging the seals at the single side of the room. Unfortunately, these systems could not ensure synchronized movement of the single side of the room with the other sides of the room (e.g., the ceiling and side walls) due to their distance from the actuators. Similarly, these systems sometimes did not evenly compress seals at the other sides of the room.

### SUMMARY OF THE INVENTION

In one aspect, the present invention provides a slide-out room system for a vehicle. The system comprises a slide-out room movably connected to the vehicle and at least four room slides supported by the vehicle and operable to move the slide-out room relative to the vehicle. A first of the four room slides is disposed in a first quadrant at a first corner of the slide-out room, a second of the four room slides is disposed in a second quadrant at a second corner of the slide-out room, a third of the four room slides is disposed in a third quadrant at a third corner of the slide-out room, and a fourth of the four room slides is disposed in a fourth quadrant at a fourth corner of the slide-out room. The system further includes a controller operatively connected to each of the four room slides for independently controlling the motion of the four room slides and synchronizing the motion of the four room slides to move the quadrants in concert with one another.

In another aspect, the slide-out room system comprises a slide-out room movably connected to the vehicle. The slide-out room has a leading wall, a ceiling, a floor, and right and left side walls extending between the ceiling and the floor. The system further includes at least four room slides supported by the vehicle and operable to move the slide-out room relative to the vehicle. A first of the four room slides is disposed in a first quadrant defined by an upper half of the right side wall, a right half of the ceiling, and an upper right quarter of the leading wall, a second of the four room slides is disposed in a second quadrant defined by a left half of the ceiling, an upper half of the left side wall, and an upper left quarter of the leading wall, a third of the four room slides is disposed in a third quadrant defined by a bottom half of the left side wall, a left half of the floor, and a bottom left quarter of the leading wall, and a fourth of the four room slides is disposed in a fourth quadrant defined by a right half of the floor, a bottom half of the right side wall, and a bottom right quarter of the leading wall. The system further includes a controller operatively connected to each of the four room slides for independently controlling the motion of the four room slides and synchronizing the motion of the four room slides to move the slide-out room in concert with one another. A control panel operatively connects to the controller and includes inputs to receive commands from a user.

In another aspect, the present invention provides a method for controlling motion of a slide-out room movably supported by a vehicle. The method comprises the steps of: a) sending a feedback signal from each of four room slides connected to the slide-out room to a controller, a first of the four room slides being disposed in a first quadrant at a first corner of the slide-out room, a second of the four room slides being disposed in a second quadrant at a second corner of the slide-out room, a third of the four room slides being disposed in a third quadrant at a third corner of the slide-out room, a fourth of the four room slides being disposed in a fourth quadrant at a fourth corner of the slide-out room; b) sending a synchronized motion signal from the controller to each of the four room slides in response to the feedback signals; and c) actuating the room slides in a synchronized manner upon receiving the synchronized motion signals and thereby moving the slide-out room.

The foregoing and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a recreational vehicle with a slide-out room system according to the present invention;

FIG. 2 is a detail perspective view of the area enclosed by line 2-2 in FIG. 1;

FIG. 3 is a section view from line 3-3 of FIG. 2 showing the structure of a room slide of the slide-out room system of FIG. 1;

FIG. 4 is a section view from line 4-4 of FIG. 2 showing the structure of the room slide of FIG. 3;

FIG. 5 is a section view from line 5-5 of FIG. 3;

FIG. 6 is a side view of the slide-out room of FIG. 1 showing four quadrants in which room slides may be positioned;

FIG. 7 is a schematic diagram of a controller and the room slides of the slide-out room system of FIG. 1;

FIG. 8 is a front view of a control panel for the slide-out room;

FIG. 9 is a rear view of the control panel for the slide-out room;

FIGS. 10a and 10b are a flow chart of a main program of the controller for controlling the room slides;

FIG. 11 is a flow chart of a subroutine of the controller to check a lock limit switch;

FIG. 12 is a flow chart of a subroutine of the controller for manual motion of the slide-out room;

FIG. 13 is a flow chart of a subroutine of the controller for inward motion synchronization;

FIG. 14 is a flow chart of a subroutine of the controller for outward motion synchronization;

FIG. 15 is a flow chart of a subroutine of the controller to set programmable stops for the room slides; and

FIG. 16 is a flow chart of an alternative subroutine of the controller for manual motion of the slide-out room.

### DETAILED DESCRIPTION OF THE PREFERRED EMBODIMENT

A slide-out room system according to the present invention provides wall movement synchronization of several walls of the room, such as the ceiling, the floor, and the side walls. As such, the system ensures the slide-out room does not move to a skewed position relative to the vehicle. Moreover, the system provides sufficient engagement between the walls of the vehicle and seals on the slide-out room. These aspects of the invention are described in further detail in the following paragraphs, beginning with the structure of the slide-out room and concluding with methods for providing synchronized movement.

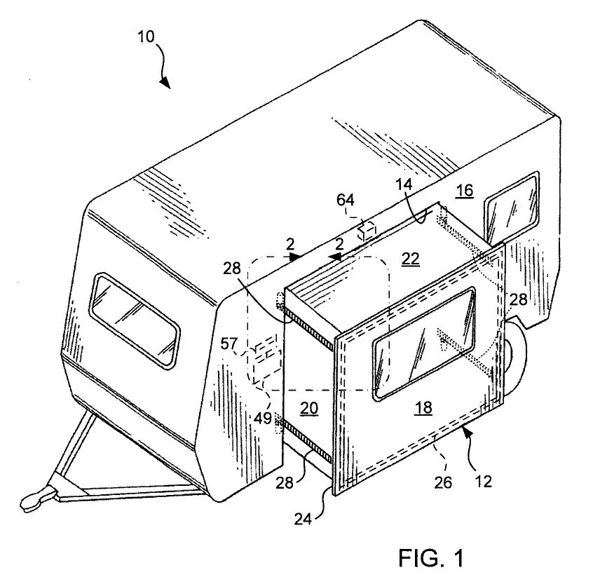

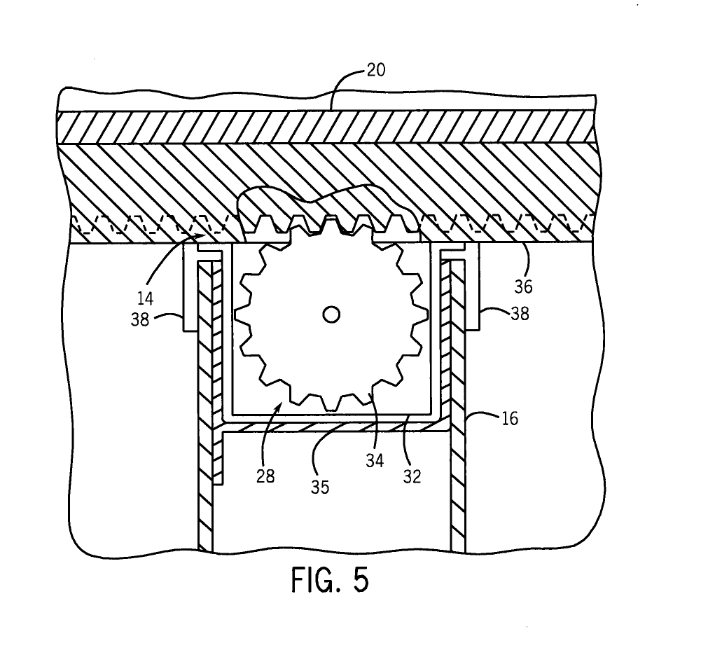

Referring first to FIGS. 1, 2, 5, and 6, a recreational vehicle 10 supports the slide-out room 12 in an opening 14 of a vehicle side wall 16. An interior of the slide-out room 12 is defined by a leading or outside wall 18, side walls 20, a ceiling 22, and a floor 23 (FIG. 5). The leading wall 18 includes a fascia 24, and the plane of the fascia 24 is parallel to the respective planes of the opening 14 and the side wall 16. The surface of the fascia 24 facing the side wall 16 includes a seal 26. The seal 26 is compressed between the fascia 24 and the side wall 16 when the slide-out room 12 is retracted to prevent leaks between the cabin of the recreational vehicle 10 and the outside environment. The side walls 20 of the slide-out room 12 also include flanges (not shown) located inside the vehicle 10. The surface of the flanges facing the side wall 16 also includes a seal (not shown) to prevent leaks between the cabin of the recreational vehicle 10 and its environment when the slide-out room 12 is extended.

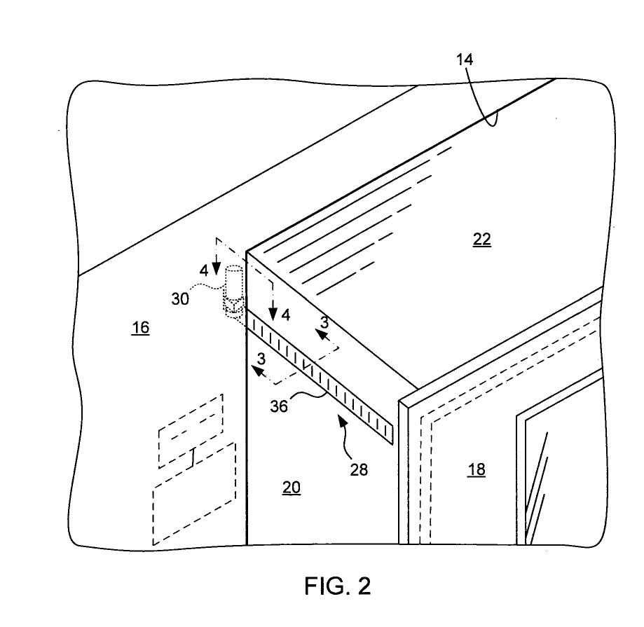

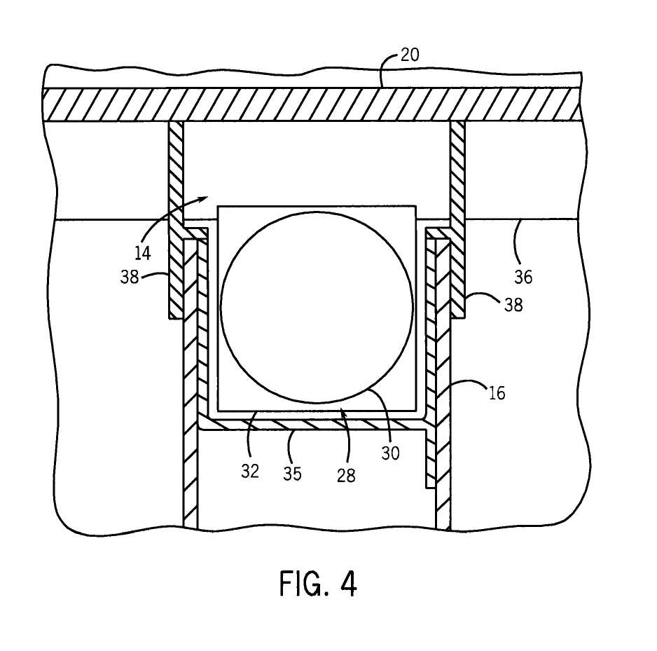

Referring now to FIGS. 2-5, the slide-out room 12 is moved between the extended and retracted positions by four rooms slides 28. In the following paragraphs, the general structure of the rooms slides 28 is first described followed by the positions of the room slides 28 on the slide-out room 12.

Each of the room slides 28 is preferably a rack and pinion actuator. That is, each of the room slides 28 preferably includes a drive motor 30, such as a 12V DC motor. In some embodiments, each drive motor 30 includes dynamic brakes (not shown) that are operatively connected to the same electrical circuit as the drive motor 30. The dynamic brakes automatically engage at the instant power to the drive motor 30 is interrupted. The dynamic brakes may also be replaced by other well-known types of brakes.

Regardless of the presence or type of brakes, the drive motor 30 drives a speed reducer 32, such as a planetary gear transmission, a spur gear transmission, a worm gear transmission, or the like, and the speed reducer 32 drives a pinion 34. The drive motor 30, speed reducer 32, and the pinion 34 are mounted by a support bracket 35 disposed within the vehicle side wall 16 and proximate the opening 14 in the side wall 16. The pinion 34 extends outwardly from the side wall 16 to engage and drive an elongated gear rack 36 connected to the slide-out room 12.

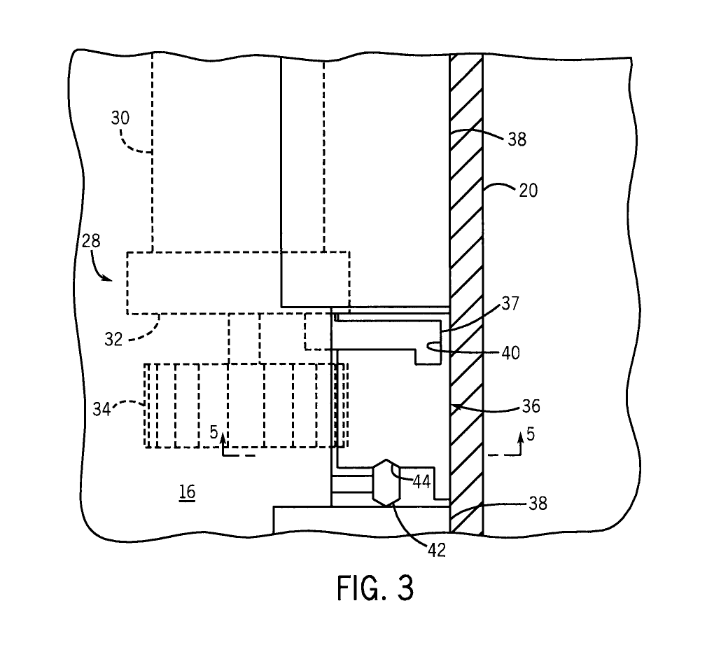

Each of the room slides 28 may include a support leg 37 (FIG. 3) received in a recess 40 of the gear rack 36 for additional support, although other suitable structures may also be used. Furthermore, each of the room slides 28 may include a rotatable wheel 42 (FIG. 3) received in a channel or groove 44 of the gear rack 36. The wheel 42 may have a v-shaped outer circumference and the groove 44 may have a mating inverted v-shaped surface.

As shown most clearly in FIGS. 3-5, the vehicle side wall 16 and the slide-out room side walls 20 are spaced apart to accommodate the gear racks 36. In order to prevent drafts and leaks through these spaces, the vehicle side wall 16 preferably supports flexible seals 38, such as elongated and generally flat polymer seals, on each side of the gear racks 36. In other embodiments, the gear racks 36 could be recessed within the slide-out room side walls 20 instead of providing flexible seals 38 or in connection with smaller flexible seals 38.

The room slides 28 may be other types of actuators, such as power screws and hydraulic actuators, without departing from the scope of the invention. However, rack and pinion actuators are preferred because the drive motors 30 may be relatively inconspicuously positioned within the vehicle side wall 16 as described above and are available at relatively low cost.

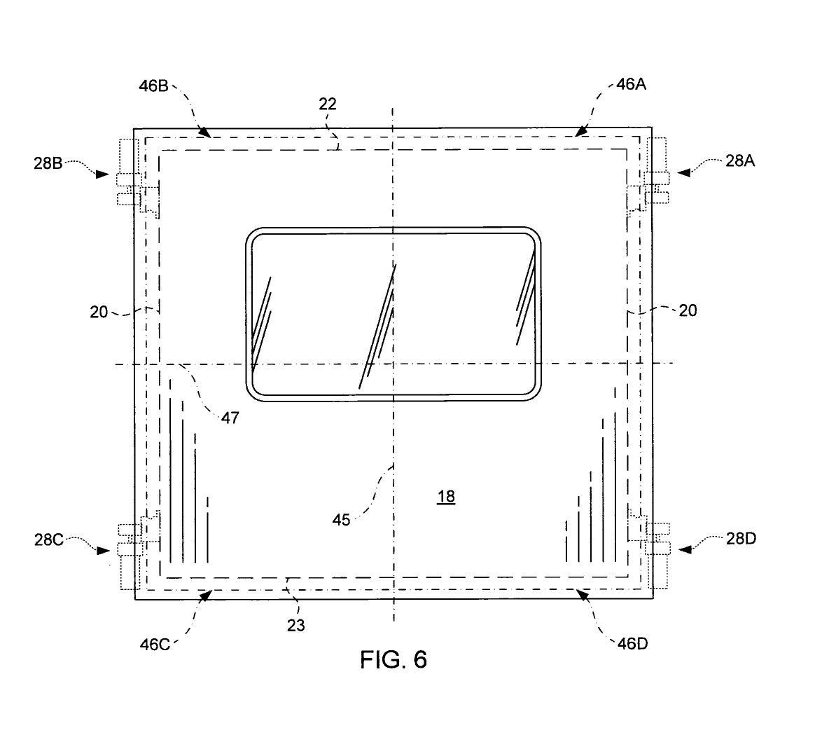

Referring again to FIGS. 1 and 6, two of the room slides 28 connect to one of the slide-out room side walls 20 and the other two of the room slides 28 connect to the other slide-out room side wall 20. Furthermore, one of the room slides 28 connected to each side wall 20 is disposed proximate the upper edge of the side wall 20 and the other of the room slides 28 connected to each side wall 20 is disposed proximate the lower edge of the side wall 20. As such, each of the room slides 28 is disposed proximate one of the edges between the side walls 20 and the ceiling 22 or floor 23. This configuration, together with the operation of a controller as described below, provides wall movement synchronization of the ceiling 22, floor 23, and side walls 20 of the slide-out room 12. That is, motion of the room slides 28 is synchronized from the top to the bottom of the slide-out room 12, from side-to-side across the slide-out room 12, and across the diagonals of the slide-out room 12. Such synchronized movement ensures the slide-out room 12 does not move to a skewed position relative to the vehicle. Furthermore, this configuration permits the room slides 28 to provide sufficient engagement between the walls of the vehicle and the seals (e.g., the outer seal 26 and the inner seal, not shown) around the entire slide-out room 12.

Other configurations of the room slides 28 also provide the above advantages. For example and referring particularly to FIG. 6, a single room slide 28 may be disposed at any position in one of four quadrants. As used herein, the term “quadrant” refers to one of the four spaces inside and outside of the leading wall 18, the side walls 20, the ceiling 22, and the floor 23 and bounded by two lines 45 and 47 that intersect each other at right angles. Specifically, a first room slide 28A is disposed in a first quadrant 46A (i.e., a quadrant at a first corner of the slide-out room 12 defined by the upper half of the right side wall 20, the right half of the ceiling 22, and the upper right quarter of the leading wall 18). A second room slide 28B is disposed in a second quadrant 46B (i.e., a quadrant at a second corner of the slide-out room 12 defined by the left half of the ceiling 22, the upper half of the left side wall 20, and the upper left quarter of the leading wall 18). A third room slide 28C is disposed in a third quadrant 46C (i.e., a quadrant at a third corner of the slide-out room 12 defined by the bottom half of the left side wall 20, the left half of the floor 23, and the bottom left quarter of the leading wall 18). A fourth room slide 28D is disposed in a fourth quadrant 46D (i.e., a quadrant at a fourth corner of the slide-out room 12 defined by the right half of the floor 23, the bottom half of the right side wall 20, and the bottom right quarter of the leading wall 18). However, in such a configuration each room slide 28 is preferably closer to the nearest upper or lower edge of the slide-out room 12 than the nearest adjacent room slide 28.

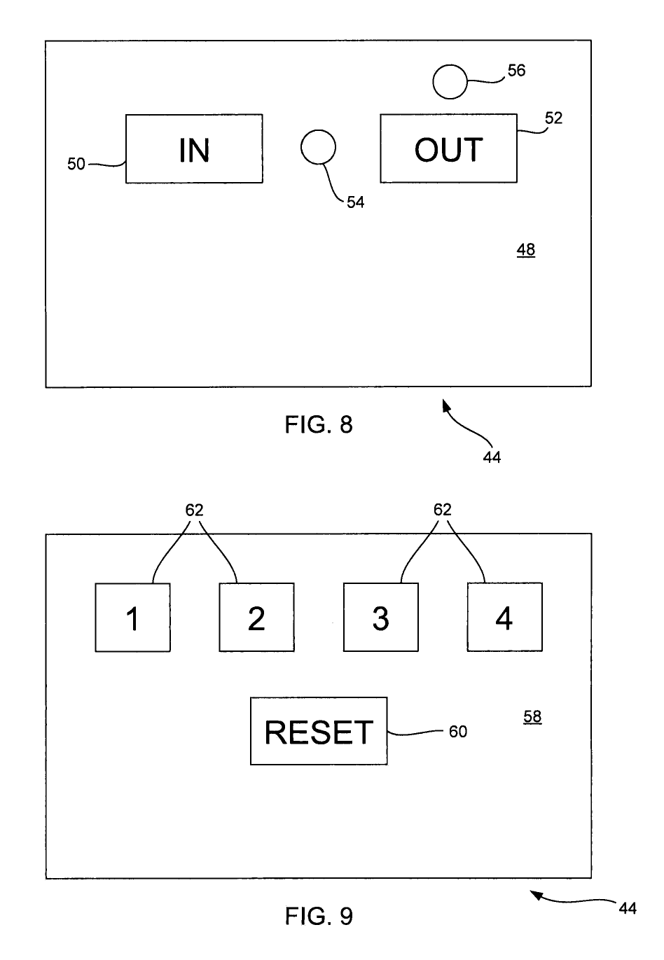

Referring now to FIGS. 1 and 7-9, the drive motor 30 of each room slide 28 is operatively connected to a controller 49. The controller 49 ensures synchronized motion of the room slides 28 by monitoring the position of each room slide 28 using a Hall effect sensor (not shown) attached to each drive motor 30. The Hall effect sensors are preferably bi-directional Hall effect sensors that are capable of indicating the direction of motion of a motor in addition to its rotational position. Alternatively, the position of each room slide 28 can be monitored by any type of position sensor, such as an optical encoder or a potentiometer. Furthermore, each room slide 28 could include a sensor that provides a different type of signal instead of a position signal, such as a velocity signal. Regardless of the type of motion feedback signal that is used, by monitoring the signal from each sensor, power is supplied to each drive motor 30 in a manner which ensures uniform extension of the room slides 28. Operation of the slide-out room will be discussed in further detail below.

A battery (not shown) is also electrically connected to the controller 49. Any suitable battery may be used as long as it satisfies the power requirements of the controller 49. Alternatively, the battery may be replaced by a power cord to connect to a 120V wall outlet. A transformer could be included in the circuit to modify the voltage obtained from the wall outlet.

The recreational vehicle 10 includes a control panel 57 that operatively connects to the controller 49. The respective positions of the controller 49 and the control panel 57 are not limited to that shown in FIG. 1; they may be located anywhere on the recreational vehicle 10. Preferably, the controller 49 is located inside a wall since it does not need to be accessed by the end user. Also, the control panel 57 is preferably inside the cabin for protection from precipitation. The control panel 57 is accommodated in such a way that the end user has access to a front face 48 of the control panel 57 to interact with various command inputs (e.g., buttons, keys, switches, or the like).

Specifically, the front face 48 of the control panel 57 includes IN button 50, OUT button 52, green movement indicating LED 54, and red fault indicating LED 56. In general, the IN button 50 moves the slide-out room to the retracted position. The OUT button 52 moves the slide-out room 12 to the extended position. The green movement indicating LED 54 indicates movement of at least one component of the control system, and red fault indicating LED 56 indicates a fault within the system. The LEDs also provide diagnostic codes which will be discussed in further detail below.

The control panel 57 is also accommodated in such a way that the back face 58 is not normally accessible by the end user. Preferably, the control panel 57 is recessed in a wall of the recreational vehicle 10. Alternatively, the back face 58 of the control panel 57 is fastened to an inner wall of the recreational vehicle 10. In either case, the control panel 57 is held in place by bolts, screws, snap-fit tabs, or the like. The back face 58 of the control panel 57 includes a reset button 60, and motor selection buttons 62. These buttons are used for resetting the programmable stops. As used herein, the term ‘programmable stops’ refers to the extended and retracted positions of the slide-out room 12 stored in the memory of the controller 49. The process for setting the programmable stops will be discussed in further detail below.

The recreational vehicle 10 also includes a lock 64 located near the slide-out room 12. The position of the lock 64 may be on the side wall 16 of the vehicle 10 as shown in FIG. 1. Alternatively, the lock 64 may be on one of the side walls 20 or the ceiling 22 of the slide-out room 12. The lock 64 is engaged when the slide-out room 12 is retracted. The lock 64 includes a lock motor (not shown) and a normally open limit switch (not shown). The lock motor and the limit switch are electrically connected to the controller. When closed, the limit switch indicates that the lock 64 is disengaged. The controller only supplies power to the room slides 28 if the lock 64 is disengaged. This process will be discussed in further detail below. In addition, the system preferably includes a current sensor (not shown) that indicates if the lock 64 is engaged. That is, the current supplied to the lock 64 will suddenly increase when the lock 64 has reached engagement. The current sensor sends a signal to the controller due to this sudden current increase and the controller stops powering the lock 64 thereafter.

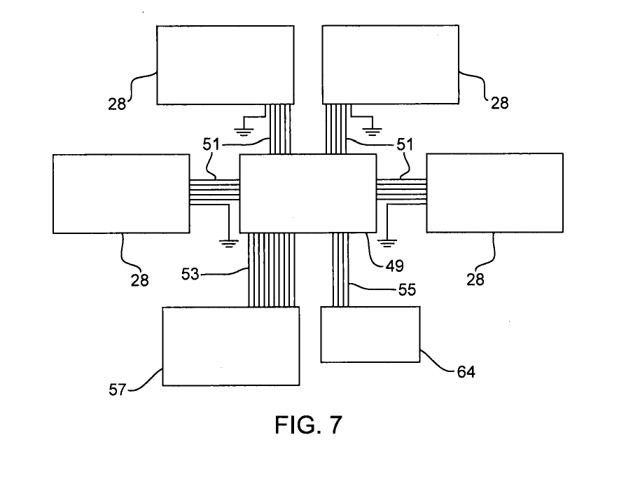

As discussed above, each room slide 28, the control panel 57, and the lock 64 are electrically connected to the controller 49. A schematic diagram of these components is shown in FIG. 7. The controller 49 preferably connects to each room slide 28 via five electrical leads 51. Two leads 51 connect to the drive motor 30 of the room slide 28 and three leads 51 connect to the Hall effect sensor of the room slide 28. Two leads 51 from the Hall effect sensor serve as common signal leads and the third lead 51 provides power from the controller 49. In addition, a sixth lead 51 connects the Hall effect sensor to ground.

The controller 49 preferably connects to the control panel 57 via ten electrical leads 53; each lead 53 corresponds to one of the seven buttons or one of the two LEDs on the control panel 57, and one lead 53 provides power from the controller 49 to the control panel 57. The controller 49 preferably connects to the lock 64 via four leads 55. Two leads 55 connect to the limit switch of the lock 64 and two leads 55 connect to the lock motor. Any appropriate gage size may be used for the leads 51, 53, and 55 and any appropriate electrical connectors may be connected to the ends of the leads to physically connect the aforementioned components.

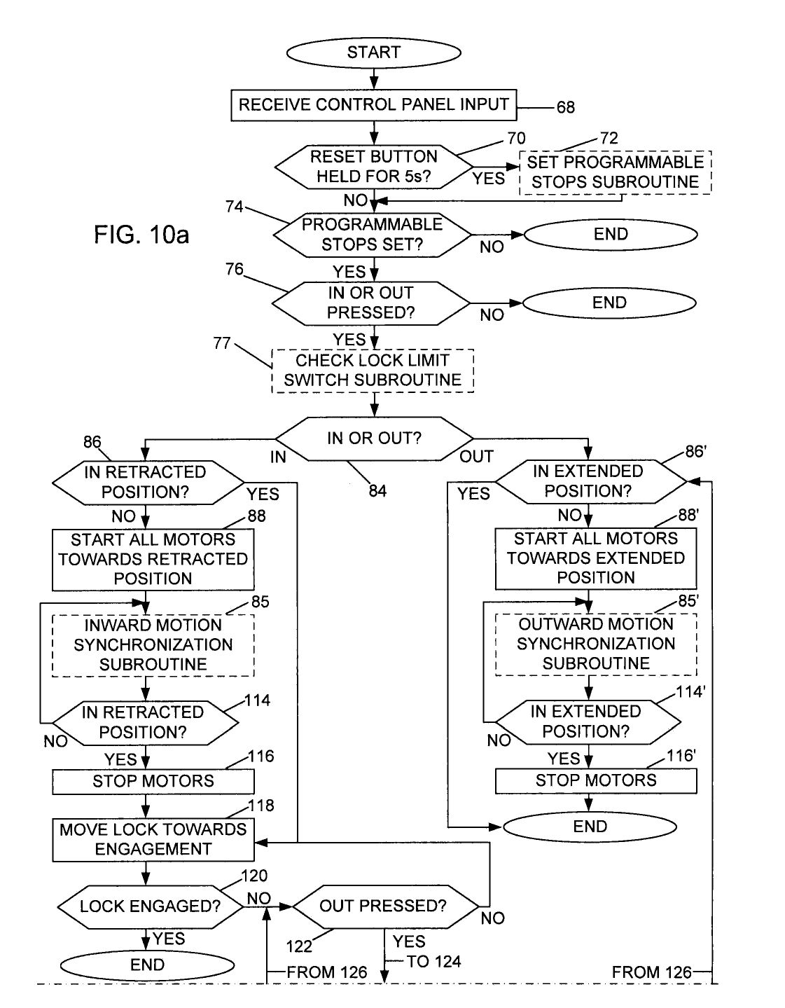

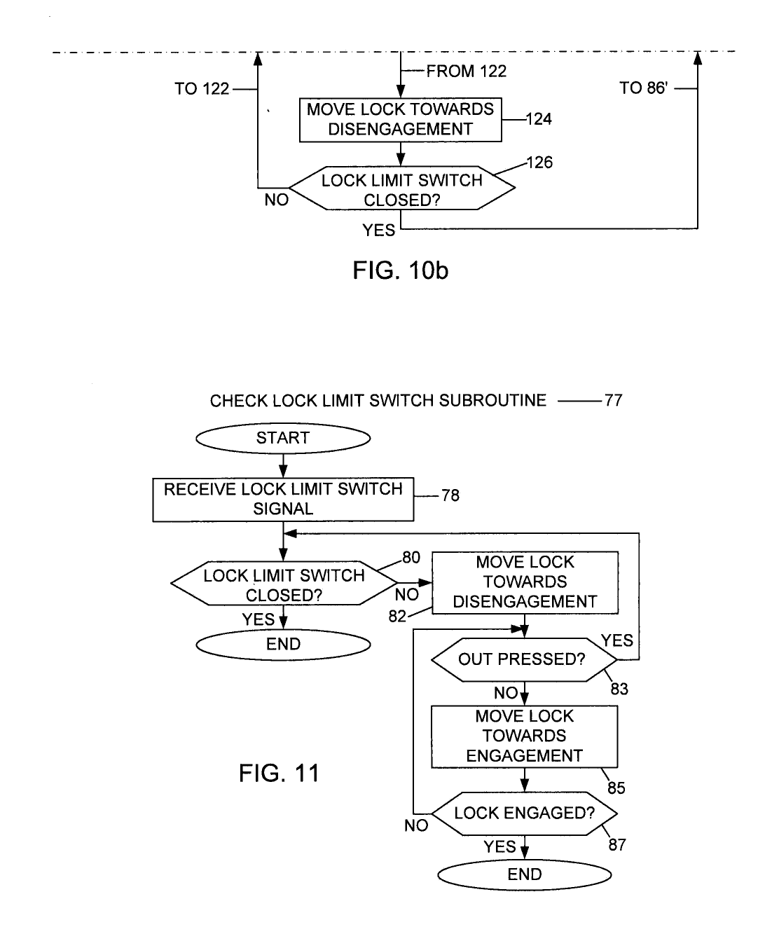

Referring now to FIGS. 10a-16, operation of the slide-out room 12 begins when a button on the control panel 57 is pressed. As indicated at program step 68, the controller 49 receives the input from the control panel 57. At 70, the controller 49 determines if the reset button 60 has been held for five seconds, which starts the subroutine to set the programmable stops 72. The subroutine to set the programmable stops 72 will be discussed in further detail below. If the reset button 60 as not been held for five seconds, the controller 49 determines if the programmable stops are set at 74. If the programmable stops are not set, the program ends. Otherwise, the controller 49 proceeds to determine if either the IN button 50 or the OUT button 52 has been pushed at 76. If neither has been pushed, the program ends. Otherwise, the controller 49 checks the limit switch attached to the lock 64 using a subroutine at 77. Referring to FIG. 11, the controller 49 receives a signal from the limit switch at 78. If the limit switch is not closed at 80, the lock 64 moves towards disengagement at 82. The OUT button 52 must be held during this subroutine 77 for the lock 64 to be disengaged as indicted at 83. Once the lock 64 is disengaged at 80, the subroutine 77 ends. However, if the OUT button 52 is released before the lock 64 is disengaged at 80, the lock 64 will move toward engagement at 85. As the lock 64 moves toward engagement at 85, the controller 49 continues to monitor the OUT button 52 at 83. If the lock 64 reaches engagement at 87, the program ends. In addition, the program will not continue at 84 on FIG. 10a, but will instead restart at the beginning since the lock 64 is engaged. Returning to the main program, the controller 49 next determines which button has been pushed at 84. If the IN button 50 has been pressed, the controller 49 checks if the slide-out room 12 is already in the retracted position at 86. If this is the case, the program does not move the room slides 28 and moves the lock 64 towards engagement. Otherwise, the controller 49 provides power to the drive motors 30 such that the slide-out room 12 moves towards the retracted position at 88.

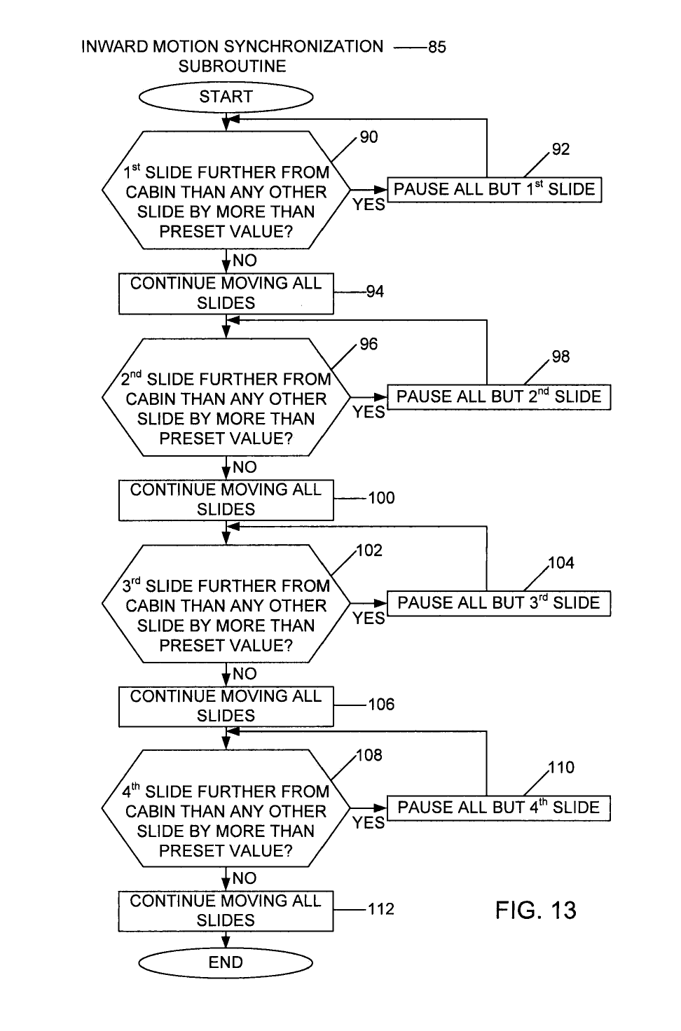

As the drive motors 30 move the slide-out room 12, the controller 49 uses an inward motion synchronization subroutine 85 (FIG. 13) to monitor the position of each room slide 28. First, the controller 49 checks the position of a first room slide (e.g., room slide 28A) relative to the other room slides at 90. If the first room slide is further from the retracted position than any other room slide by a preset limit, all other room slides are stopped momentarily at 92. All other room slides remain stationary until the first room slide is no longer further from the retracted position than any other room slide by the preset limit, as shown at 94. The controller 49 also checks the locations of the second, third, and fourth room slides (e.g., room slides 28B, 28C, and 28D, respectively) at 96, 102, and 108 respectively. If the second, third, or fourth room slide is further from the retracted position than any other room slide by the preset limit, all other room slides are stopped momentarily at 98, 104, and 110 respectively. All other room slides remain stationary until the second, third, or fourth room slide is no longer further from the retracted position than any other room slide by the preset limit, as shown at 100, 106, and 112, respectively. At 114, the controller 49 checks the position of the room slides 28. If the room slides 28 are not in the retracted position, the drive motors 30 continue to run and the controller 49 continues to synchronize the motion of the room slides 28. Otherwise, the drive motors 30 are stopped at 116.

The lock 64 is automatically engaged as follows. At 118, the lock motor receives power from the controller 49 and moves the lock 64 towards the engagement position. If the lock 64 reaches the engagement position at 120, the program ends. However, while the lock 64 is moving, the OUT button 52 may be pressed as shown at 122. Pressing and holding the OUT button 52 moves the lock 64 towards disengagement at 124. If the OUT button 52 is released before the lock is disengaged at 126, the lock 64 will return to 118 and move towards engagement. Otherwise, if the lock is disengaged at 126, the program will extend the room slides 28 starting at 86′.

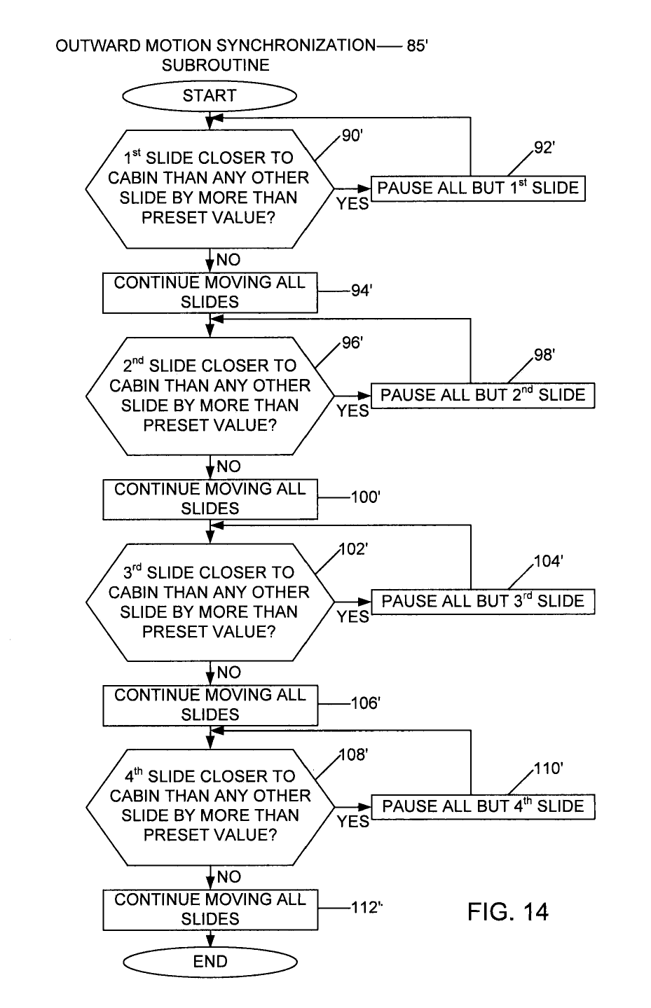

It should be noted that the process to move the slide-out room 12 to the extended position is similar to the process described above. Specifically, this process includes the steps 86′, 88′, 90′, 92′, 94′, 96′, 98′, 100′, 102′, 104′, 106′, 108′, 110′, 112′, 114′, and 116′, as shown in FIGS. 10a and 14. However, the lock 64 is not engaged after the slide-out room 12 reaches the extended position.

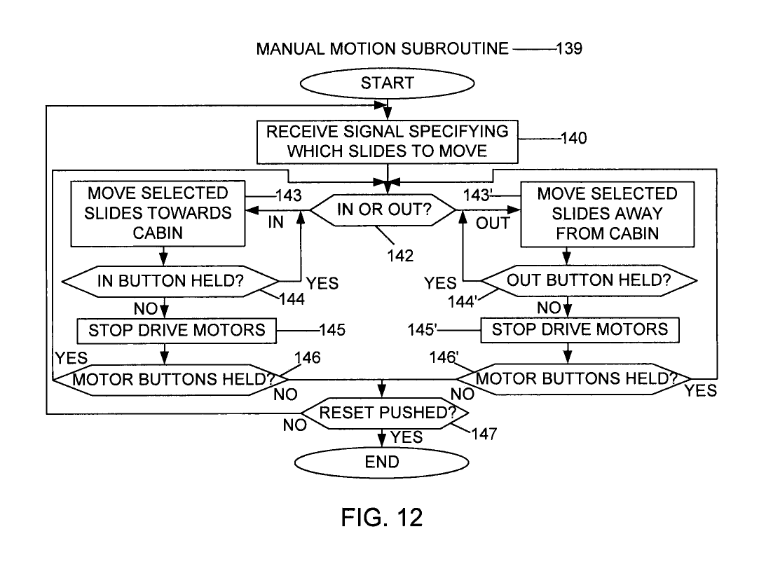

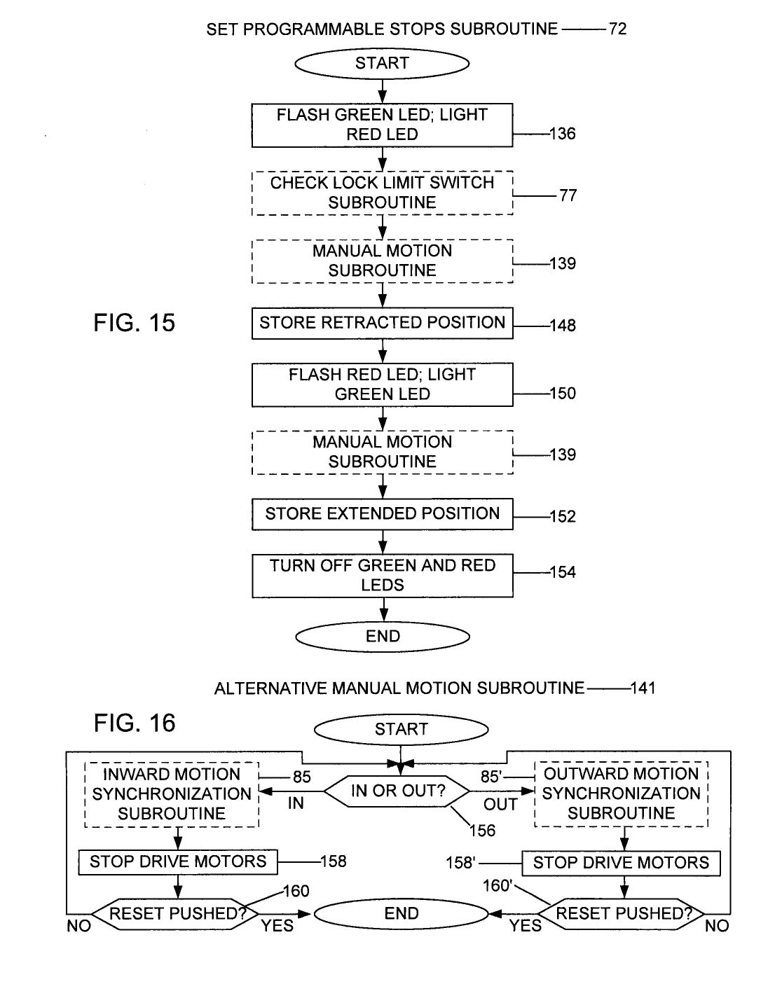

Holding the reset button 60 for five seconds starts the subroutine to set the programmable stops 72. As shown in FIG. 15, the green movement indicating LED 54 flashes and the red fault indicating LED 56 is lit at 136 to indicate the subroutine to set the programmable stops 72 has been entered. At 77, the lock limit switch is checked using the subroutine 77. Next, the program enters a manual motion subroutine 139 (FIG. 12) permitting the user to move the slide-out room 12 to the retracted position. The user presses any combination of the motor selection buttons 62. The controller 49 receives a signal from the control panel 57 specifying which motor selection buttons 62 are pressed at 140. Next, the controller 49 determines whether the IN button 50 or the OUT button 52 is pressed at 142. If the IN button 50 is pressed, the selected drive motors 30 are powered and move the slide-out room 12 towards the cabin at 143. The selected drive motors 30 are powered as long as the IN button 50 is held, as indicated by 144. When the IN button 50 is released, the drive motors 30 are stopped at 145. Next, the controller 49 determines if the previous combination of motor selection buttons 62 is still held at 146. If this is the case, the program returns to determine whether the IN button 50 or the OUT button 52 is pressed at 142. Otherwise, the program proceeds to determine if the reset button 60 is pressed at 147. If it is not, the program returns to the beginning of the manual motion subroutine 139. If the reset button 60 is pressed, the retracted position of the slide-out room 12 is stored at 148. It should be understood that pressing the OUT button 52 results in using similar programming steps (143′, 144′, 145′, and 146′) to those of pressing the IN button 50.

Next, the user proceeds to set the extended position of the slide-out room 12. This is indicated by the red fault indicating LED 56 flashing and the green movement indicating LED 54 remaining lit at 150. The program calls the manual motion subroutine 139 permitting the user to move the slide-out room 12 to the extended position. The manual motion subroutine 139 ends when the reset button is pushed at 147, and the extended position of the slide-out room 12 is stored at 152. The green movement indicating LED 54 and the red fault indicating LED 56 turn off at 154 to indicate that the retracted and extended positions have been programmed successfully. Alternatively, the green movement indicating LED 54 flashes rapidly for 10 seconds to indicate that the retracted and extended positions have not been programmed successfully. In addition, the controller 49 includes a timeout mechanism in the subroutine to set the programmable stops 72. If no button is pushed for 45 seconds, the program will exit this subroutine and return to the main program.

An alternative manual motion subroutine 141 can use the inward motion synchronization subroutine 85 and the outward motion synchronization subroutine 85′ as shown in FIG. 16. In this subroutine, the controller 49 determines whether the IN button 50 or the OUT button 52 has been pressed at 156. If the IN button 50 has been pressed, the drive motors 30 are powered to move the slide-out room 12 towards the cabin of the recreational vehicle 10. As long as the IN button 50 is held, the drive motors 30 continue to move using the inward motion synchronization subroutine 85. When the IN button 50 is released, the drive motors 30 are stopped at 158. At 160, the controller 49 determines if the reset button 60 has been pressed. If the reset button 60 has not been pressed, the program returns to step 156 to determine if the IN button 50 or the OUT button 52 has been pressed. If the reset button 60 has been pressed, the program exits the subroutine. It should be understood that pressing the OUT button 52 results in using similar programming steps (85′, 158′, and 160′) to those of pressing the IN button 50.

The controller 49 also includes fault detection capabilities and a means for communicating faults to the user. Motion of the slide-out room 12 will automatically stop in any part of the program if any fault is detected. The slide-out room 12 will not move until the fault is resolved. The faults recognized by the controller 49 include those listed in the following table.

| Fault | Fault | | | |
|---|---|---|---|---|
| Code | Type | Description | Probable Cause | Solution |
| 1 | Major | Stops not programmed. | No programmable stops | Set programmable stops. |
| | | | have been set for the | |
| | | | control. | |
| 2 | Minor | Battery dropout voltage; | Bad lead connection from | Repair bad lead |
| | | voltage dropped below 8.0 V | battery to control or low | connection or replace |
| | | while room was moving. | battery. | battery. |
| 3 | Minor | Low battery voltage; voltage | Bad lead connection from | Repair bad lead |
| | | is below 10.5 V when room | battery to control or low | connection or replace |
| | | movement was initiated. | battery. | battery. |
| 4 | Minor | Excessive battery voltage; | Bad battery. | Replace battery. |
| | | battery voltage is above | | |
| | | 18.0 V when room movement | | |
| | | was initiated. | | |
| 5 | Major | Drive motor drawing | Excessive system/room | Remove obstruction, re- |
| | | excessive current. | drag, obstruction, | adjust room, reset stops |
| | | | improper stop locations or | or replace damaged |
| | | | damaged component. | component. |
| 6 | Major | Drive motor shorted. | Shorted wiring or motor. | Inspect motor harness |
| | | | | leads and motor for |
| | | | | shorts; replace shorted |
| | | | | component. |
| 7 | Major | Drive motor open. | Bad connection or motor. | Repair bad lead |
| | | | | connection or replace |
| | | | | motor. |
| 8 | Major | No signal on motor sensor | Bad lead connection or | Repair bad lead |
| | | OUT 1 (yellow) lead. | sensor. | connection or replace |
| | | | | motor. |
| 9 | Major | No signal on motor sensor | Bad lead connection or | Repair bad lead |
| | | OUT 2 (blue) lead. | sensor. | connection or replace |
| | | | | motor. |
| 10 | Major | No signal on motor sensor | Bad lead connection or | Repair bad lead |
| | | OUT 1 (yellow) lead and no | sensor. | connection or replace |
| | | signal on motor sensor OUT | | motor. |
| | | 2 (blue) lead. | | |
| 11 | Major | Lock motor drawing | Excessive drag or | Remove obstruction or |
| | | excessive current. | obstruction or damaged | replace damaged |
| | | | component. | component. |
| 12 | Major | Lock motor short. | Shorted wiring or motor. | Inspect motor harness |
| | | | | leads and motor for |
| | | | | shorts; replace shorted |
| | | | | component. |
| 13 | Major | Lock motor open. | Bad connection or motor. | Repair bad lead |
| | | | | connection or replace |
| | | | | motor |
| 14 | Minor | Lock timeout. | Obstruction or low | Remove obstruction, |
| | | | voltage. | repair bad lead |
| | | | | connection or replace |
| | | | | battery. |

Minor faults are addressed using the solutions in the fifth column. The IN button 50 and the OUT button 52 may be used to move the slide-out room 12 immediately after a minor fault is resolved. Major faults are also addressed using the solutions in the fifth column. However, the reset button 60 must be pressed before the IN button 50 and the OUT button 52 may be used to move the slide-out room 12 after a major fault is resolved.

Faults are communicated to the user via the LEDs 54 and 56. The red fault indicating LED 56 flashes a number of times corresponding to the fault code number listed in the table. Additionally, some faults may only occur for individual drive motors 30. The green movement indicating LED 54 flashes a number of times corresponding to the number of the affected motor. Additionally, the battery dropout voltage, low battery voltage, and excessive battery voltage values (8.0V, 10.5V, and 18.0V in the table) can be modified to any values appropriate for the battery used with the recreational vehicle 10. Also, the excessive current value can be specified based on the current input requirements of the drive motors 30 and the lock motor.

The structure of the above system may be modified in various manners or operate in different manners without departing from the scope of the invention. For example, instead of providing synchronized motion as described above, the system may achieve synchronized motion using methods as described in U.S. Pat. No. 6,536,823, U.S. Pat. No. 6,345,854, U.S. Pat. No. 6,471,275, or U.S. Pat. No. 6,696,813, the disclosures of which are hereby incorporated by reference. As another example, the system could have more than four room slides, and multiple room slides could be positioned in one or more of the four quadrants outside the slide-out room.

It is specifically intended that the present invention not be limited to the embodiments and illustrations contained herein, but include modified forms of those embodiments including portions of the embodiments and combinations of elements of different embodiments as defined within the scope of the following claims.

What is claimed is:

1. A slide-out room system for a vehicle, comprising:
a slide-out room movably connected to the vehicle;
at least four room slides supported by the vehicle and operable to move the slide-out room relative to the vehicle, a first of the four room slides being disposed in a first quadrant at a first corner of the slide-out room, a second of the four room slides being disposed in a second quadrant at a second corner of the slide-out room, a third of the four room slides being disposed in a third quadrant at a third corner of the slide-out room, a fourth of the four room slides being disposed in a fourth quadrant at a fourth corner of the slide-out room; and
a controller operatively connected to each of the four room slides for independently controlling motion of the four room slides and synchronizing the motion of the four room slides to move the quadrants in concert with one another.

2. The slide-out room system of claim 1, wherein the slide-out room has a leading wall, a ceiling, a floor, and right and left side walls extending between the ceiling and the floor, the first quadrant is defined by an upper half of the right side wall, a right half of the ceiling, and an upper right quarter of the leading wall, the second quadrant is defined by a left half of the ceiling, an upper half of the left side wall, and an upper left quarter of the leading wall, the third quadrant is defined by a bottom half of the left side wall, a left half of the floor, and a bottom left quarter of the leading wall, and the fourth quadrant is defined by a right half of the floor, a bottom half of the right side wall, and a bottom right quarter of the leading wall.

3. The slide-out room system of claim 2, wherein each of the four room slides is spaced apart from a nearest edge between one of the sides walls and one of the ceiling and the floor by a first distance, each of the four room slides is spaced apart from the nearest of the other of the four room slides by a second distance, and the second distance is greater than the first distance.

4. The slide-out room system of claim 2, wherein the right side wall of the slide-out room directly supports the first room slide and the fourth room slide, and the left side wall of the slide-out room directly supports the second room slide and the third room slide.

5. The slide-out room system of claim 1, wherein each of the four room slides includes a drive motor operatively connected to the controller.

6. The slide-out room system of claim 5, wherein each of the four room slides further includes a pinion driven by the drive motor and a gear rack driven by the pinion.

7. The slide-out room system of claim 6, wherein each gear rack is directly supported by the slide-out room.

8. The slide-out room system of claim 1, further comprising a control panel including inputs to receive commands from a user, the control panel being operatively connected to the controller.

9. A slide-out room system for a vehicle, comprising:
a slide-out room movably connected to the vehicle, the slide-out room having a leading wall, a ceiling, a floor, and right and left side walls extending between the ceiling and the floor;
at least four room slides supported by the vehicle and operable to move the slide-out room relative to the vehicle, a first of the four room slides being disposed in a first quadrant defined by an upper half of the right side wall, a right half of the ceiling, and an upper right quarter of the leading wall, a second of the four room slides being disposed in a second quadrant defined by a left half of the ceiling, an upper half of the left side wall, and an upper left quarter of the leading wall, a third of the four room slides being disposed in a third quadrant defined by a bottom half of the left side wall, a left half of the floor, and a bottom left quarter of the leading wall, and a fourth of the four room slides being disposed in a fourth quadrant defined by a right half of the floor, a bottom half of the right side wall, and a bottom right quarter of the leading wall;
a controller operatively connected to each of the four room slides for independently controlling motion of the four room slides and synchronizing the motion of the four room slides to move the slide-out room in concert with one another; and
a control panel operatively connected to the controller and including inputs to receive commands from a user.

10. The slide-out room system of claim 9, wherein each of the four room slides includes a drive motor operatively connected to the controller.

11. The slide-out room system of claim 9, wherein each of the four room slides is spaced apart from a nearest edge between one of the sides walls and one of the ceiling and the floor by a first distance, each of the four room slides is spaced apart from the nearest of the other of the four room slides by a second distance, and the second distance is greater than the first distance.

12. The slide-out room system of claim 11, wherein the right side wall of the slide-out room directly supports the first room slide and the fourth room slide, and the left side wall of the slide-out room directly supports the second room slide and the third room slide.

13. A method for controlling motion of a slide-out room movably supported by a vehicle, the method comprising the steps of:
sending a feedback signal from each of four room slides connected to the slide-out room to a controller, a first of the four room slides being disposed in a first quadrant at a first corner of the slide-out room, a second of the four room slides being disposed in a second quadrant at a second corner of the slide-out room, a third of the four room slides being disposed in a third quadrant at a third corner of the slide-out room, a fourth of the four room slides being disposed in a fourth quadrant at a fourth corner of the slide-out room;
sending a synchronized motion signal from the controller to each of the four room slides in response to the feedback signals; and
actuating the room slides in a synchronized manner upon receiving the synchronized motion signals and thereby moving the slide-out room.

14. The method of claim 13, wherein each of the four room slides includes a drive motor operatively connected to the controller to send the feedback signal to the controller and receive the synchronized motion signal from the controller.

15. The method of claim 13, wherein the slide-out room has a leading wall, a ceiling, a floor, and right and left side walls extending between the ceiling and the floor, the first quadrant is defined by an upper half of the right side wall, a right half of the ceiling, and an upper right quarter of the leading wall, the second quadrant is defined by a left half of the ceiling, an upper half of the left side wall, and an upper left quarter of the leading wall, the third quadrant is defined by a bottom half of the left side wall, a left half of the floor, and a bottom left quarter of the leading wall, and the fourth quadrant is defined by a right half of the floor, a bottom half of the right side wall, and a bottom right quarter of the leading wall.

16. The method of claim 15, wherein each of the four room slides is spaced apart from a nearest edge between one of the sides walls and one of the ceiling and the floor by a first distance, each of the four room slides is spaced apart from the nearest of the other of the four room slides by a second distance, and the second distance is greater than the first distance.

17. The method of claim 13, wherein the feedback signal is a position signal.

18. The method of claim 13, further comprising the step of programming stop positions for each of the four room slides in the controller.
